(19) United States
(12) Patent Application Publication
(10) Pub. No.: US 2025/0052778 A1
(43) Pub. Date: Feb. 13, 2025

(54) MOVEMENT AMOUNT ESTIMATION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: ATSUSHI NARISHIGE, Nisshin-shi (JP); SAKON YAMAMOTO, Nisshin-shi (JP)

(21) Appl. No.: 18/669,671

(22) Filed: May 21, 2024

(30) Foreign Application Priority Data
Aug. 9, 2023 (JP) 2023-129822

(51) Int. Cl. G01P 13/00

(52) U.S. Cl. CPC G01P 13/00

(57) ABSTRACT

A movement amount estimation device includes an external movement amount acquisition unit configured to acquire an external movement amount as a movement amount of a moving body using external information, an internal movement amount acquisition unit configured to acquire an internal movement amount as the movement amount of the moving body using internal information, and a movement amount estimation unit configured to estimate the movement amount of the moving body using at least one of the external movement amount and the internal movement amount. The movement amount estimation unit is further configured to acquire a difference between the external movement amount and the internal movement amount, and determine whether to use the external movement amount or the internal movement amount to estimate the movement amount depending on whether the difference is equal to or less than a predetermined threshold value.

### CROSS REFERENCE TO RELATED APPLICATION

The present application claims the benefit of priority from Japanese Patent Application No. 2023-129822 filed on Aug. 9, 2023. The entire disclosure of the above application is incorporated herein by reference.

### TECHNICAL FIELD

The present disclosure relates to a movement amount estimation device.

### BACKGROUND

There has been known a vehicle position estimation device that estimates a movement amount of a vehicle using an external device provided outside the vehicle and an internal device provided in the vehicle.

### SUMMARY

A movement amount estimation device according to an aspect of the present disclosure includes an external movement amount acquisition unit, an internal movement amount acquisition unit, and a movement amount estimation unit. The external movement amount acquisition unit is configured to acquire an external movement amount as a movement amount of a moving body using external information related to an object located outside the moving body and detected by an external sensor provided in the moving body. The internal movement amount acquisition unit is configured to acquire an internal movement amount as the movement amount of the moving body using internal information related to a movement of the moving body and detected by an internal sensor provided in the moving body. The movement amount estimation unit is configured to estimate the movement amount of the moving body using at least one of the external movement amount and the internal movement amount. The movement amount estimation unit is further configured to acquire a difference between the external movement amount and the internal movement amount, and determine whether to use the external movement amount or the internal movement amount to estimate the movement amount of the moving body depending on whether the difference between the external movement amount and the internal movement amount is equal to or less than a predetermined threshold value.

A movement amount estimation device according to another aspect of the present disclosure includes a processor and a memory. The memory stores a computer program including instructions configured to, when executed by the processor, cause the processor to: acquire an external movement amount as a movement amount of a moving body using external information related to an object located outside the moving body and detected by an external sensor provided in the moving body; acquire an internal movement amount as the movement amount of the moving body using internal information related to a movement of the moving body and detected by an internal sensor provided in the moving body; acquire a difference between the external movement amount and the internal movement amount; determine whether to use the external movement amount or the internal movement amount to estimate the movement amount of the moving body depending on whether the difference between the external movement amount and the internal movement amount is equal to or less than a predetermined threshold value; and estimate the movement amount of the moving body using at least one of the external movement amount and the internal movement amount.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram showing a configuration of a movement amount estimation device according to a first embodiment;

FIG. 2 is a block diagram showing an internal functional configuration of the movement amount estimation device;

FIG. 3 is a graph showing a change in an error in an external movement amount with respect to a movement distance; and

FIG. 4 is a flowchart showing a processing routine in a process for estimating a movement amount of a vehicle.

### DETAILED DESCRIPTION

Next, a relevant technology is described only for understanding the following embodiments. A vehicle position estimation device according to a relevant technology includes a radio position estimation unit and a vehicle position estimation unit. The radio position estimation unit calculates a movement amount of a vehicle based on a relative positional relationship between an external radio provided outside the vehicle and an internal radio provided in the vehicle. The vehicle position estimation unit calculates the movement amount of the vehicle using information from a sensor that detects a wheel speed and the like. The vehicle position estimation device compares the movement amount calculated by the radio position estimation unit with the movement amount calculated by the vehicle position estimation unit, and corrects the movement amount of the vehicle so as to reduce a difference between the two calculated amounts.

In the above-described vehicle position estimation device, the external radio provided outside the vehicle is used to correct the movement amount of the vehicle. However, there is a demand for estimating a movement amount of a vehicle using only a device provided in the vehicle. In this case, it is desirable to restrict an influence of noise on a detection result from a viewpoint of improving an accuracy of detecting the movement amount.

A movement amount estimation device according to an aspect of the present disclosure includes an external movement amount acquisition unit, an internal movement amount acquisition unit, and a movement amount estimation unit. The external movement amount acquisition unit is configured to acquire an external movement amount as a movement amount of a moving body using external information related to an object located outside the moving body and detected by an external sensor provided in the moving body. The internal movement amount acquisition unit is configured to acquire an internal movement amount as the movement amount of the moving body using internal information related to a movement of the moving body and detected by an internal sensor provided in the moving body. The movement amount estimation unit is configured to estimate the movement amount of the moving body using at least one of the external movement amount and the internal movement amount. The movement amount estimation unit is further configured to acquire a difference between the external movement amount and the internal movement amount, and determine whether to use the external movement amount or the internal movement amount to estimate the movement amount of the moving body depending on whether the difference between the external movement amount and the internal movement amount is equal to or less than a threshold value.

A movement amount estimation device according to another aspect of the present disclosure includes a processor and a memory. The memory stores a computer program including instructions configured to, when executed by the processor, cause the processor to: acquire an external movement amount as a movement amount of a moving body using external information related to an object located outside the moving body and detected by an external sensor provided in the moving body; acquire an internal movement amount as the movement amount of the moving body using internal information related to a movement of the moving body and detected by an internal sensor provided in the moving body; acquire a difference between the external movement amount and the internal movement amount; determine whether to use the external movement amount or the internal movement amount to estimate the movement amount of the moving body depending on whether the difference between the external movement amount and the internal movement amount is equal to or less than a predetermined threshold value; and estimate the movement amount of the moving body using at least one of the external movement amount and the internal movement amount.

According to each of the movement amount estimation devices described above, it is possible to determine whether the acquired external movement amount or the acquired internal movement amount includes an instantaneous error, based on whether the difference between the external movement amount and the internal movement amount is equal to or less than the threshold value. Therefore, by using either the external movement amount or the internal movement amount in which no instantaneous error has occurred, it is possible to restrict the influence of the instantaneous error in estimating the movement amount.

### First Embodiment

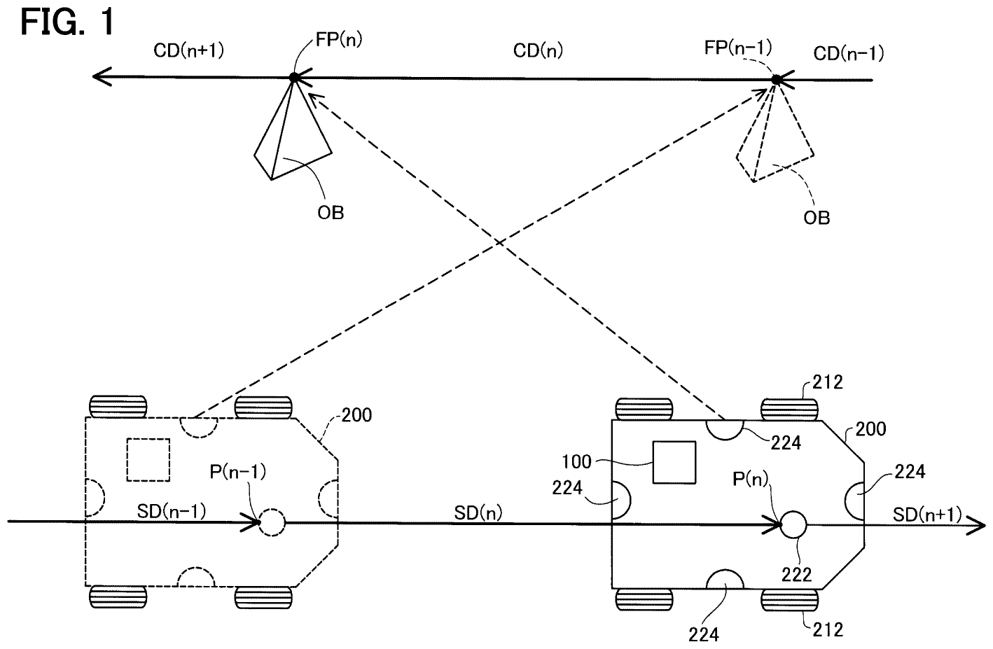

FIG. 1 is an explanatory diagram showing a configuration of a movement amount estimation device 100 according to a first embodiment of the present disclosure. The movement amount estimation device 100 estimates the movement amount of a vehicle 200. The movement amount of the vehicle 200 is, for example, the amount of translational and rotational movement including a rotation matrix and a translation matrix. In the present embodiment, the movement amount estimation device 100 is an electronic control unit (ECU) mounted on the vehicle 200, and is capable of executing various types of control of the vehicle 200, such as driving control. The movement amount estimation device 100 may be provided in the vehicle 200 as a separate entity from an ECU, or may be realized by a device outside the vehicle 200, such as an external server.

The result of estimating the movement amount of the vehicle 200 by the movement amount estimation device 100 is used for a driving control of the vehicle 200. The “driving control of the vehicle 200” refers to, for example, an autonomous driving control that controls autonomous driving of the vehicle 200, a driving assistance control, and the like. The driving assistance control includes a lane keeping control for driving the vehicle 200 along a driving lane, a risk avoidance control, and the like. The “risk avoidance control” refers to a control that performs at least one of steering control and braking control to reduce a risk of collision between the vehicle 200 and an object. In the driving control of the vehicle 200, information related to the position of the vehicle 200 is used. The position of the vehicle 200 is estimated using the movement amount of the vehicle 200 estimated by the movement amount estimation device 100.

The vehicle 200 may be, for example, a passenger car, a truck, a bus, a construction vehicle, or the like. In the present embodiment, the vehicle 200 is a battery electric vehicle (BEV). The vehicle 200 is not limited to the battery electric vehicle, but may be, for example, a gasoline vehicle, a hybrid vehicle, or a fuel cell vehicle. The vehicle 200 is equipped with an internal sensor 222, an external sensor 224, and the movement amount estimation device 100.

The internal sensor 222 detects internal information, which is data related to the traveling of the vehicle 200. The movement amount of the vehicle 200 can be acquired by using the internal information or analyzing the internal information. The internal information may be, for example, the movement amount of the vehicle 200, the position of the vehicle 200, or various data related to the traveling of the vehicle 200 from which the movement amount of the vehicle 200 or the position of the vehicle 200 can be acquired. The movement amount of the vehicle 200 acquired using the internal information is also referred to as the “internal movement amount”.

In the present embodiment, the internal sensor 222 is a wheel speed sensor provided on a wheel 212, and the internal information is the amount of rotation of the wheel 212, a rotation speed of the wheel 212, or the like. For example, the movement amount of the vehicle 200 as the internal movement amount can be obtained by multiplying the amount of rotation obtained by the internal sensor 222 by a circumference of the wheel 212. The internal sensor 222 is not limited to the wheel speed sensor, but may be a steering angle sensor, a yaw rate sensor, an inertial measurement unit (IMU), a global navigation satellite system (GNSS) receiver, or any combination of these components. The internal movement amount may be a scalar value indicating a distance traveled by the vehicle 200, or a vector value including a distance traveled by the vehicle 200, a turning angle of the vehicle 200, and the like.

FIG. 1 conceptually illustrates the internal movement amount SD(n). The internal movement amount SD(n) is the movement amount of the vehicle 200 acquired from the detection result of the internal sensor 222. The internal movement amount SD(n) can be calculated, for example, based on a history of the wheel speed and a steering angle detected during a period from the previous processing routine to the current processing routine. If the position of vehicle 200 at the current processing routine is vehicle position P(n), and the position of vehicle 200 at or before the previous processing routine is vehicle position P(n−1), the movement amount from the previous vehicle position P(n−1) to the current vehicle position P(n) is the current internal movement amount SD(n). FIG. 1 also shows the previous internal movement amount SD(n−1) and the next internal movement amount SD(n+1).

The external sensor 224 detects external information, which is data related to an object OB outside the vehicle 200. The object OB is, for example, a stationary object such as a white line, a pole, a telephone pole, a sign, a billboard, or a building. the movement amount of the vehicle 200 can be acquired using the external information or analysis thereof. The external information may be the movement amount of the object OB, the position of the object OB, or various data related to the object OB from which the movement amount of the object OB or the position of the object OB can be acquired. The movement amount of the vehicle 200 acquired using the external information is also referred to as the “external movement amount”.

In the present embodiment, the external sensor 224 is a multi-camera including four fisheye cameras disposed on the front, rear, left and right sides of the vehicle 200, and the external information is image data of the object OB and the like. It should be noted that the fisheye cameras are cameras that use fisheye lenses. However, the external sensor 224 may also be a multi-camera including pinhole cameras instead of or in addition to the fisheye cameras. When the pinhole cameras are used, objects outside the vehicle 200 can be detected by the external sensor 224 having a simple configuration. The external sensor 224 is not limited to a camera, but may be a laser imaging detection and ranging (LiDAR) or a radar device. When the external sensor 224 is the LiDAR, the external information is three-dimensional point cloud data. The three-dimensional point cloud data is data that indicates a three-dimensional position of a point cloud. The external movement amount may be a scalar value indicating a distance traveled by the vehicle 200, or a vector value including a distance traveled by the vehicle 200, a turning angle of the vehicle 200, and the like.

FIG. 1 conceptually illustrates an external movement amount CD(n). The external movement amount CD(n) is the movement amount of the vehicle 200 obtained from the detection result of the external sensor 224. The absolute position of the object OB in the absolute coordinate system is known. A relative position FP(n) of the object OB with respect to the external sensor 224 is calculated based on the detection result by the external sensor 224. The external movement amount CD(n) is, for example, the movement amount from the relative position FP(n−1) calculated in the previous processing routine to the relative position FP(n) calculated in the current processing routine. When the position of the object OB at the current processing routine is defined as the relative position FP(n), and the position of the object OB at or before the previous processing routine is defined as the relative position FP(n−1), the movement amount from the previous relative position FP(n−1) to the current relative position FP(n) is the current external movement amount CD(n). FIG. 1 also shows the previous external movement amount CD(n−1) and the next external movement amount CD(n+1).

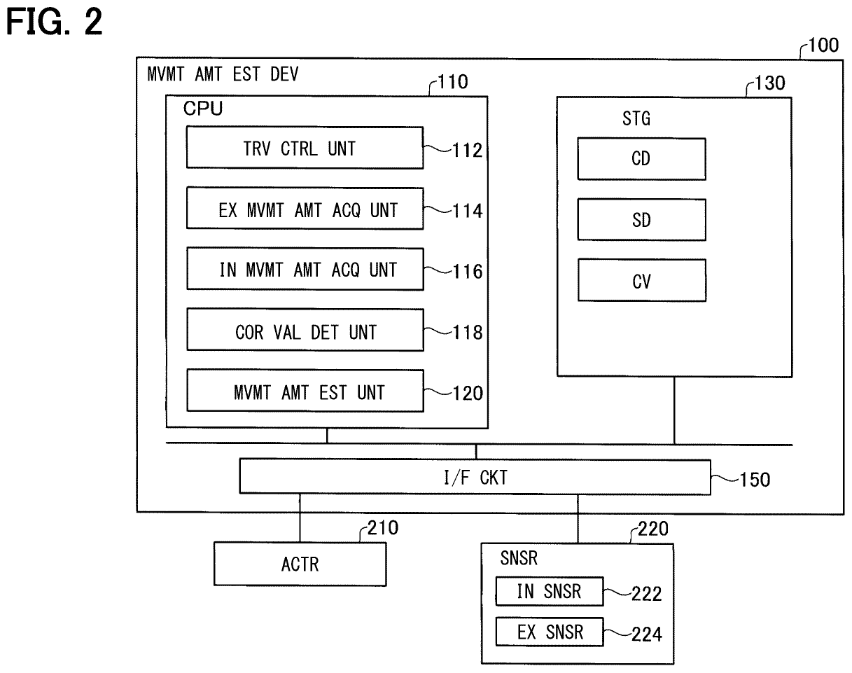

FIG. 2 is a block diagram showing an internal functional configuration of the movement amount estimation device (MVMT AMT EST DEV) 100. The movement amount estimation device 100 includes a central processing unit (CPU) 110, a storage device (STG) 130, and an interface circuit (I/F CKT) 150. The CPU 110 is also referred to as a processor, and the storage device 130 is also referred to as a memory. The CPU 110, the storage device 130, and the interface circuit 150 are connected via an internal bus so as to be capable of bidirectional communication. The interface circuit 150 is connected to a group of actuators (ACTR) 210 and sensors (SNSR) 220 including the internal sensor (IN SNSR) 222 and the external sensor (EX SNSR) 224. When the movement amount estimation device 100 is disposed outside the vehicle 200, a communication device for communicating with the vehicle 200 via a network or the like may be further connected to the interface circuit 150.

The storage device 130 is, for example, a hard disk drive (HDD), a solid state drive (SSD), an optical recording medium, a semiconductor memory, or the like. The external movement amount CD, the internal movement amount SD, and a correction value CV are stored in a readable and writable area of the storage device 130. The correction value CV is used to calculate the movement amount of the vehicle 200, as described below. In the present embodiment, the correction value CV is corrected so that the internal movement amount SD matches the external movement amount CD. The correction value CV can be obtained, for example, by calculating the difference between the external movement amount CD and the internal movement amount SD.

The storage device 130 stores a computer program including instructions for implementing at least a part of functions provided in the present embodiment. When the computer program stored in the storage device 130 is executed by the CPU 110, the CPU 110 functions as a traveling control unit (TRV CTRL UNT) 112, an external movement amount acquisition unit (EX MVMT AMT ACQ UNT) 114, an internal movement amount acquisition unit (IN MVMT AMT ACQ UNT) 116, a correction value determination unit (COR VAL DET UNT) 118, and a movement amount estimation unit (MVMT AMT EST UNT) 120. However, some or all of these functions may be configured using hardware circuits.

The traveling control unit 112 executes a traveling control of the vehicle 200 and a driving control of the vehicle 200. The “driving control” refers to various controls for driving the group of actuators 210 that provides functions of running, turning, and stopping of the vehicle 200, such as adjusting acceleration, speed, and steering angle. The group of actuators 210 includes actuators for a driving device for accelerating the vehicle 200, actuators for a braking device for decelerating the vehicle 200, and actuators for a steering device for changing the travel direction of the vehicle 200.

The external movement amount acquisition unit 114 acquires the external movement amount CD using the external information detected by the external sensor 224. The acquired external movement amount CD is stored in the storage device 130. The internal movement amount acquisition unit 116 acquires the internal movement amount SD using the internal information detected by the internal sensor 222. The acquired internal movement amount SD is stored in the storage device 130.

The correction value determination unit 118 determines the correction value CV. In the present embodiment, the correction value determination unit 118 determines the correction value CV corresponding to a determination result as to whether or not a gradual error occurs in the internal movement amount SD, or an instantaneous error occurs in the internal movement amount SD or the external movement amount CD. The determined correction value CV is stored in the storage device 130.

The internal movement amount SD and the external movement amount CD during a given period may not match with each other. For example, the internal movement amount SD may include an error (hereinafter also referred to as a “gradual error”) that may gradually accumulate due to variations or changes in a diameter of the wheels 212, a decrease in an air pressure of the wheels 212, and the like. The gradual error generally increases with increase in travel distance of the vehicle 200. The acquired internal movement amount SD is corrected using the correction value CV, so that the detected value of the internal movement amount SD is matched with the external movement amount CD. As a result, the influence of the gradual error can be reduced, and the accuracy of estimating the movement amount of the vehicle 200 can be improved.

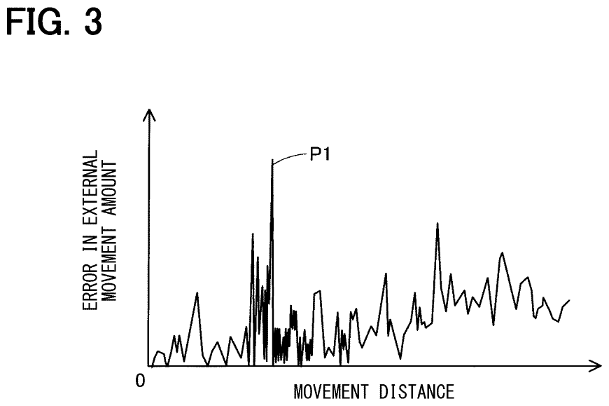

FIG. 3 is a graph showing the change in error of the external movement amount with respect to the movement distance. The horizontal axis indicates the movement distance of the vehicle 200, and the vertical axis indicates the magnitude of the detection error of the external movement amount. For example, in a case where the external sensor 224 is a camera, poor visibility outside the vehicle 200 may cause a detection error of characteristic points of the object OB. In this case, as shown by an error P1 in FIG. 3, a temporary error due to the detection error may occur in the external movement amount CD. The temporary error is also referred to as an “instantaneous error”. In the internal sensor 222, the instantaneous error may occur in the internal movement amount SD, for example, when the wheels 212 slip or spin while traveling. If the movement amount of the vehicle 200 is calculated in a state where the instantaneous error is included, the accuracy of estimating the movement amount of the vehicle 200 decreases. Therefore, it is desirable to detect whether the acquired external movement amount CD or the acquired internal movement amount SD includes the instantaneous error, and calculate the movement amount of the vehicle 200 using a calculation method or the correction value CV corresponding to the detection result.

Whether the external movement amount CD or the internal movement amount SD includes the instantaneous error is determined by checking a deviation between the external movement amount CD and the internal movement amount SD. For example, a difference between the external movement amount CD and the internal movement amount SD is calculated, and whether the external movement amount CD or the internal movement amount SD includes the instantaneous error can be determined whether the difference exceeds a predetermined threshold value. In the present embodiment, the threshold value is set to the correction value CV determined during the previous processing routine (also referred to as the “previous correction value”). Specifically, it is estimated that the instantaneous error has occurred when the current difference, which is the difference between the external movement amount CD and the current internal movement amount SD acquired in the current processing routine, is larger than the previous difference, which is the difference between the external movement amount CD and the previous internal movement amount SD acquired in the previous processing routine. The current difference is equal to the correction value CV determined in the current processing routine (also referred to as the “current correction value”), and the previous difference is equal to the correction value CV determined in the previous processing routine. The threshold value may be set to the correction value CV determined before the previous processing routine, such as the correction value CV determined in a processing routine before the previous processing routine. The threshold value may be set to a fixed value, or may be set optionally using a past correction value CV, such as an average value of the correction values CV determined in the previous processing routine and processing routines before the previous processing routine.

The movement amount estimation unit 120 shown in FIG. 2 estimates the movement amount of the vehicle 200. The movement amount estimation unit 120 estimates the movement amount using at least one of the internal movement amount SD, the external movement amount CD, and the correction value CV acquired in the current processing routine, or the internal movement amount SD, the external movement amount CD, and the correction value CV stored in the storage device 130. In the present embodiment, the movement amount estimation unit 120 estimates the movement amount of the vehicle 200 differently depending on whether the instantaneous error has occurred in the internal movement amount SD or the external movement amount CD, as described below.

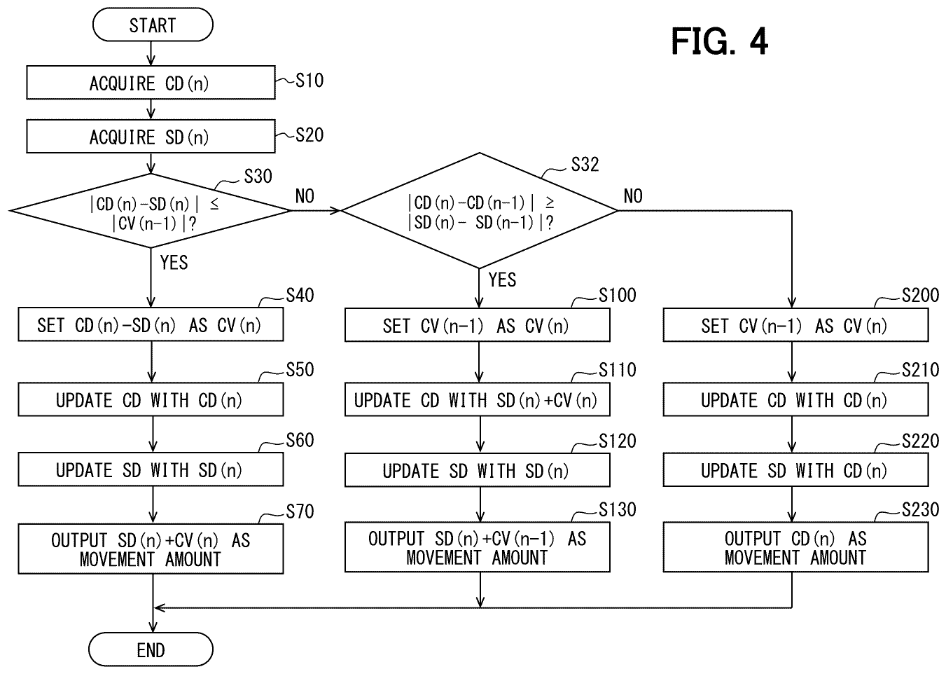

FIG. 4 is a flowchart showing a processing routine in the process of estimating the movement amount of the vehicle 200. This flow is started, for example, when the vehicle 200 or the movement amount estimation device 100 is activated. This flow can be repeatedly executed at predetermined time intervals, such as 1 second or 0.1 seconds.

In S10, the external movement amount acquisition unit 114 acquires the detection result of the external sensor 224 and calculates the current external movement amount. The current external movement amount calculated in the current processing routine is also referred to as the “external movement amount CD(n)”. The external movement amount CD stored in the storage device 130 is also referred to as the “previous external movement amount” or the “external movement amount CD(n−1)”.

In S20, the internal movement amount acquisition unit 116 acquires the detection result of the internal sensor 222 and calculates the current internal movement amount. The current internal movement amount calculated in the current processing routine is also referred to as the “internal movement amount SD(n)”. The internal movement amount SD stored in the storage device 130 is also referred to as the “previous internal movement amount” or the “internal movement amount SD(n−1)”.

In S30, the movement amount estimation unit 120 checks whether the difference between the external movement amount CD(n) and the internal movement amount SD(n) is equal to or less than the correction value CV serving as the threshold value. The correction value CV used in S30 is the correction value CV stored in the storage device 130. The correction value CV stored in the storage device 130 is also referred to as the “previous correction value” or the “correction value CV(n−1)”.

In the present embodiment, the movement amount estimation unit 120 checks whether the absolute value of the difference between the external movement amount CD(n) and the internal movement amount SD(n) is equal to or less than the absolute value of the correction value CV. Specifically, the movement amount estimation unit 120 checks whether the following mathematical formula (1) is satisfied. By using the mathematical formula (1), it is possible to determine whether the instantaneous error has occurred in either the external movement amount CD(n) or the internal movement amount SD(n).

$$\vert The external movement amount CD ( n ) - the internal movement amount S D ( n ) \vert \leq \vert the correction value C V ( n - 1 ) \vert \qquad ( 1 )$$

When the mathematical formula (1) is satisfied (S30: YES), that is, when it is determined that no instantaneous error has occurred, the movement amount estimation unit 120 transitions the process to S40. In S40, the correction value determination unit 118 sets the calculated value of “the external movement amount CD(n)−the internal movement amount SD(n)” as the correction value CV(n). The correction value determination unit 118 overwrites and updates the correction value CV stored in the storage device 130 with the determined correction value CV(n).

In S50, the movement amount estimation unit 120 overwrites and updates the external movement amount CD stored in the storage device 130 with the acquired external movement amount CD(n). In S60, the movement amount estimation unit 120 overwrites and updates the internal movement amount SD stored in the storage device 130 with the acquired internal movement amount SD(n).

In S70, the movement amount estimation unit 120 acquires the value obtained by adding the correction value CV(n) determined in S40 to the current internal movement amount SD(n) as the movement amount of the vehicle 200. The movement amount estimation unit 120 outputs the acquired movement amount of the vehicle 200 to the traveling control unit 112, and ends this flow.

In S30, when the mathematical formula (1) is not satisfied (S30: NO), the movement amount estimation unit 120 transitions the process to S32. In S32, the movement amount estimation unit 120 compares the difference between the external movement amount CD(n) and the external movement amount CD(n−1) (hereinafter also referred to as an “external movement amount difference”) with the difference between the internal movement amount SD(n) and the internal movement amount SD(n−1) (hereinafter also referred to as an “internal movement amount difference”). Specifically, the movement amount estimation unit 120 checks whether the following mathematical formula (2) is satisfied. By using the mathematical formula (2), it is possible to determine whether the instantaneous error has occurred in either the internal movement amount SD or the external movement amount CD.

$$\vert The external movement amount CD ( n ) - the external movement amount CD ( n - 1 ) \vert \geq \vert the internal movement amount S D ( n ) - the internal movement amount S D ( n - 1 ) \vert \qquad ( 2 )$$

When the mathematical formula (2) is satisfied (S32: YES), the movement amount estimation unit 120 transitions the process to S100. The mathematical formula (2) is satisfied when it is determined that the instantaneous error has occurred in the external movement amount CD(n). In S100, the correction value determination unit 118 sets the previous correction value CV(n−1) stored in the storage device 130 as the current correction value CV(n). That is, the correction value determination unit 118 does not update the correction value CV stored in the storage device 130. Accordingly, it is possible to restrict the movement amount of the vehicle 200 from being estimated by a correction value calculated using the external movement amount CD(n) in which the instantaneous error has occurred. It should be noted that S100 may be omitted.

In S110, the movement amount estimation unit 120 overwrites and updates the external movement amount CD stored in the storage device 130 with a calculated value obtained by adding the correction value CV(n) to the internal movement amount SD(n). By updating the external movement amount CD with the calculation result using the internal movement amount SD, it is possible to restrict the movement amount of the vehicle 200 from being estimated using the external movement amount CD(n) in which it is determined that the instantaneous error has occurred. In S120, similarly to S60, the movement amount estimation unit 120 overwrites and updates the internal movement amount SD stored in the storage device 130 with the acquired internal movement amount SD(n).

In S130, the movement amount estimation unit 120 adds the correction value CV(n) set in S100, that is, the correction value CV(n−1), to the acquired current internal movement amount SD(n), and acquires the resulting value as the movement amount of the vehicle 200. The movement amount estimation unit 120 outputs the acquired movement amount of the vehicle 200 to the traveling control unit 112, and ends this flow.

In S32, when the mathematical formula (2) is not satisfied (S32: NO), the movement amount estimation unit 120 transitions the process to S200. The mathematical formula (2) is not satisfied when it is determined that the instantaneous error has occurred in the internal movement amount SD(n). In S200, the correction value determination unit 118 sets the previous correction value CV(n−1) stored in the storage device 130 as the current correction value CV(n). That is, the correction value determination unit 118 does not update the correction value CV stored in the storage device 130. Accordingly, it is possible to restrict the movement amount of the vehicle 200 from being estimated by a correction value calculated using the internal movement amount SD(n) in which the instantaneous error has occurred. It should be noted that S200 may be omitted.

In S210, the movement amount estimation unit 120 overwrites and updates the external movement amount CD stored in the storage device 130 with the acquired external movement amount CD(n). In S220, the movement amount estimation unit 120 overwrites and updates the internal movement amount SD stored in the storage device 130 with the acquired external movement amount CD(n). By updating the internal movement amount SD with the external movement amount CD(n), it is possible to restrict the movement amount of the vehicle 200 from being estimated using the internal movement amount SD(n) in which the instantaneous error has occurred.

In S230, the movement amount estimation unit 120 adds the correction value CV(n) set in S200, that is, the correction value CV(n−1), to the acquired current external movement amount CD(n), and acquires the resulting value as the movement amount of the vehicle 200. The movement amount estimation unit 120 outputs the acquired movement amount of the vehicle 200 to the traveling control unit 112, and ends this flow.

As described above, according to the movement amount estimation device 100 of the present embodiment, the movement amount estimation unit 120 determines which one of the acquired external movement amount CD(n) or the acquired internal movement amount SD(n) should be used to estimate the movement amount of the vehicle 200, depending on whether the difference between the external movement amount CD and the internal movement amount SD is equal to or less than the predetermined threshold value. Depending on whether the difference between the external movement amount CD and the internal movement amount SD is equal to or less than the threshold value, it can be determined whether the acquired external movement amount CD(n) or the acquired internal movement amount SD(n) includes the instantaneous error. Therefore, by using either the external movement amount CD(n) or the internal movement amount SD(n) in which no instantaneous error has occurred, the influence of the instantaneous error can be restricted in the next estimation of the movement amount of the vehicle 200.

The movement amount estimation device 100 of the present embodiment further includes the correction value determination unit 118 that determines the correction value CV based on whether the difference between the acquired external movement amount CD(n) and the acquired internal movement amount SD(n) is equal to or less than the threshold value. Since the correction value CV is determined based on whether the instantaneous error is included in either the acquired external movement amount CD(n) or the acquired internal movement amount SD(n), it is possible to restrict the correction value CV from being used to calculate the movement amount when the instantaneous error has occurred. Therefore, the influence of the instantaneous errors in estimating the movement amount of the vehicle 200 can be restricted.

According to the movement amount estimation device 100 of the present embodiment, the threshold value is determined using the previous correction value CV(n−1) determined in or before the previous processing routine. The correction value determination unit 118 determines the correction value CV(n) based on whether the current difference, which is the difference between the external movement amount CD(n) acquired in the current processing routine and the internal movement amount SD(n) acquired in the current processing routine, is equal to or less than the previous correction value CV(n−1). By using the correction value that has been determined in the past and has a proven track record as the threshold value, it is possible to increase the probability of detecting the instantaneous error using the threshold value.

According to the movement amount estimation device 100 of the present embodiment, when the current difference is equal to or less than the previous correction value CV(n−1), the correction value determination unit 118 determines the correction value CV by taking the current difference as the current correction value CV(n). The movement amount estimation unit 120 estimates the movement amount of the vehicle 200 using the internal movement amount SD(n) acquired in the current processing routine and the determined correction value CV. When it is estimated that no instantaneous error has occurred, the estimation accuracy of the movement amount of the vehicle 200 can be improved by correcting the internal movement amount SD(n) to match the external movement amount CD(n).

According to the movement amount estimation device 100 of the present embodiment, when the current difference is greater than the previous correction value CV(n−1), the correction value determination unit 118 determines the correction value CV by setting the previous correction value CV(n−1) as the current correction value CV(n). When it is estimated that the instantaneous error has occurred, the correction value is not updated, so that the influence of the instantaneous error can be restricted in the next estimation of the movement amount of the vehicle 200.

According to the movement amount estimation device 100 of the present embodiment, when the current difference is greater than the previous correction value CV(n−1), the movement amount estimation unit 120 acquires an external movement amount difference, which is a different between the current external movement amount and the previous external movement amount, and an internal movement amount difference, which is a difference between the current internal movement amount and the previous internal movement amount. The movement amount estimation unit 120 determines whether to use the acquired external movement amount CD or the acquired internal movement amount SD to estimate the movement amount, depending on whether the external movement amount difference is equal to or greater than the internal movement amount difference. Depending on whether the external movement amount difference is equal to or greater than the internal movement amount difference, it can be determined whether the instantaneous error has occurred in the external movement amount CD(n) or the internal movement amount SD(n). Therefore, by using one of the acquired external movement amount CD or the acquired internal movement amount SD in which no instantaneous error has occurred, the estimation accuracy of the movement amount of the vehicle 200 can be improved.

According to the movement amount estimation device 100 of the present embodiment, when the external movement amount difference is equal to or greater than the internal movement amount difference, the correction value determination unit 118 determines the correction value CV by setting the previous correction value CV(n−1) as the current correction value CV(n). The movement amount estimation unit 120 estimates the movement amount of the vehicle 200 using the currently acquired internal movement amount SD(n) and the determined correction value CV. When it is estimated that the instantaneous error has occurred in the external movement amount CD(n), the correction value CV is not updated, and the previous correction value CV(n−1) and the internal movement amount SD(n) are used. Thus, it is possible to reduce the influence of the instantaneous error.

According to the movement amount estimation device 100 of the present embodiment, when the external movement amount difference is less than the internal movement amount difference, the correction value determination unit 118 determines the correction value CV by setting the previous correction value CV(n−1) as the current correction value CV(n). The movement amount estimation unit 120 estimates the movement amount of the vehicle 200 using the external movement amount CD(n) acquired in the current processing routine. When it is estimated that the instantaneous error has occurred in the internal movement amount SD(n), the correction value CV is not updated, and the external movement amount CD(n) is used instead of the internal movement amount SD(n). Thus, it is possible to reduce the influence of the instantaneous error.

### Other Embodiments

In the above-described first embodiment, the example has been described in which the vehicle 200 is the passenger car, the truck, the bus, the construction vehicle, or the like. However, the vehicle 200 is not limited to these vehicles, and may include various automobiles such as two-wheeled vehicles and four-wheeled vehicles, trains, and the like. Also, various moving bodies other than the vehicle 200 may be used. The “moving bodies” means objects that can move. Examples of the moving bodies include electric vertical take-off and landing aircraft (so-referred to as flying cars), ships, aircraft, robots, linear motor cars, and the like. In this case, the expressions “vehicle” and “car” in the present disclosure can be replaced with “moving body” as appropriate, and the expression “travel” can be replaced with “movement” as appropriate.

The control unit and method described in the present disclosure may be implemented by a dedicated computer which is configured with a memory and a processor programmed to execute one or more particular functions embodied in the computer program of the memory. Alternatively, the control unit and the method according to the present disclosure may be achieved by a dedicated computer which is configured with a processor with one or more dedicated hardware logic circuits. Alternatively, the control unit and the method according to the present disclosure may be achieved using one or more dedicated computers which is configured by a combination of a processor and a memory programmed to execute one or more functions and a processor with one or more hardware logic circuits. The computer program may be stored, as instructions to be executed by a computer, in a tangible non-transitory computer-readable medium.

The present disclosure should not be limited to the embodiments described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all, replacement or combination can be appropriately performed. Also, if the technical features are not described as essential in the present specification, they can be deleted as appropriate.

What is claimed is:

1. A movement amount estimation device comprising:
an external movement amount acquisition unit configured to acquire an external movement amount as a movement amount of a moving body using external information related to an object located outside the moving body and detected by an external sensor provided in the moving body;
an internal movement amount acquisition unit configured to acquire an internal movement amount as the movement amount of the moving body using internal information related to a movement of the moving body and detected by an internal sensor provided in the moving body; and
a movement amount estimation unit configured to estimate the movement amount of the moving body using at least one of the external movement amount and the internal movement amount, wherein
the movement amount estimation unit is further configured to
acquire a difference between the external movement amount and the internal movement amount, and
determine whether to use the external movement amount or the internal movement amount to estimate the movement amount of the moving body depending on whether the difference between the external movement amount and the internal movement amount is equal to or less than a threshold value.

2. The movement amount estimation device according to claim 1, further comprising
a correction value determination unit configured to determine a correction value according to whether the difference between the external movement amount and the internal movement amount is equal to or less than the threshold value, wherein
the movement amount estimation unit is further configured to estimate the movement amount of the moving body using the internal movement amount and the correction value determined by the correction value determination unit.

3. The movement amount estimation device according to claim 2, wherein
the movement amount estimation unit is further configured to set the threshold value using a previous correction value that is determined using the correction value determined in or before a previous processing routine, and
the correction value determination unit is further configured to determine the correction value differently depending on whether a current difference, which is a difference between the external movement amount acquired in a current processing routine and the internal movement amount acquired in the current processing routine, is equal to or less than the previous correction value.

4. The movement amount estimation device according to claim 3, wherein
the correction value determination unit is further configured to set the current difference as the correction value when the current difference is equal to or less than the previous correction value, and
the movement amount estimation unit is further configured to estimate the movement amount using the internal movement amount acquired in the current processing routine and the correction value determined by the correction value determination unit.

5. The movement amount estimation device according to claim 3, wherein
the correction value determination unit is further configured to set the previous correction value as the correction value in the current processing routine when the current difference is greater than the previous correction value.

6. The movement amount estimation device according to claim 5, wherein
the movement amount estimation unit is further configured to
acquire an external movement amount difference and an internal movement amount difference when the current difference is greater than the previous correction value, the external movement amount difference being a difference between the external movement amount acquired in the current processing routine and the external movement amount acquired in the previous processing routine, the internal movement amount difference being a difference between the internal movement amount acquired in the current processing routine and the internal movement amount acquired in the previous processing routine, and
determine whether to use the external movement amount or the internal movement amount to estimate the movement amount depending on whether the external movement amount difference is equal to or greater than the internal movement amount difference.

7. The movement amount estimation device according to claim 6, wherein
the correction value determination unit is further configured to set the previous correction value as the correction value in the current processing routine when the external movement amount difference is greater than the internal movement amount difference, and
the movement amount estimation unit is configured to estimate the movement amount using the internal movement amount acquired in the current processing routine and the correction value determined by the correction value determination unit.

8. The movement amount estimation device according to claim 6, wherein
the correction value determination unit is further configured to set the previous correction value as the correction value in the current processing routine when the external movement amount difference is less than the internal movement amount difference, and
the movement amount estimation unit is further configured to estimate the movement amount of the moving body using the external movement amount acquired in the current processing routine.

9. The movement amount estimation device according to claim 1, wherein
the external sensor is a multi-camera including a plurality of fisheye cameras.

10. The movement amount estimation device according to claim 1, wherein
the external sensor is a multi-camera including a plurality of pinhole cameras.

11. The movement amount estimation device according to claim 1, wherein
the internal sensor is a wheel speed sensor.

12. The movement amount estimation device according to claim 1, wherein
the movement amount estimated by the movement amount estimation unit is a scalar value indicating a movement distance of the moving body, or a vector value including the movement distance of the moving body and a turning angle of the moving body.

13. A movement amount estimation device comprising a processor and a memory, the memory storing a computer program including instructions configured to, when executed by the processor, cause the processor to:
acquire an external movement amount as a movement amount of a moving body using external information related to an object located outside the moving body and detected by an external sensor provided in the moving body;
acquire an internal movement amount as the movement amount of the moving body using internal information related to a movement of the moving body and detected by an internal sensor provided in the moving body;
acquire a difference between the external movement amount and the internal movement amount;
determine whether to use the external movement amount or the internal movement amount to estimate the movement amount of the moving body depending on whether the difference between the external movement amount and the internal movement amount is equal to or less than a predetermined threshold value; and
estimate the movement amount of the moving body using at least one of the external movement amount and the internal movement amount.
